(19) United States
(12) Patent Application Publication
(10) Pub. No.: US 2016/0031266 A1
(43) Pub. Date: Feb. 4, 2016

(54) PNEUMATIC TIRE

(71) Applicant: Kumho Tire Co., Inc., Gwangju (KR)

(72) Inventor: Kyoung Moon JEONG, Gwangju (KR)

(21) Appl. No.: 14/807,332

(22) Filed: Jul. 23, 2015

(30) Foreign Application Priority Data
Jul. 30, 2014 (KR) 10-2014-0097477

(51) Int. Cl. B60C 3/06; B60C 9/30

(52) U.S. Cl. CPC B60C 3/06; B60C 9/30; B60C 2013/006

(57) ABSTRACT

The present invention provides a pneumatic tire including a tread portion, a cap ply, a carcass, an apex, a bead, a side portion, and a belt and having asymmetrical structure with respect to a central line C in a width direction. Moreover, the pneumatic tire includes the technical feature that outer diameters of a left side and a right side are equal, while rim diameters of the left side and the right side are different, and thicknesses of the left side portion and the right side portion are different.

### CROSS REFERENCE TO RELATED APPLICATION(S)

This application claims the benefit of Korean Patent Application No. 10-2014-0097477, filed Jul. 30, 2014, which is hereby incorporated by reference in its entirety, including any figures, tables, or drawings.

### FIELD OF THE INVENTION

The present invention relates to a pneumatic tire including a tread portion, a cap ply, a carcass, an apex, a bead, a side portion, and a belt; and more particularly, the pneumatic tire having asymmetrical structure with respect to a central line in a width direction of a pneumatic tire.

### BACKGROUND OF THE INVENTION

In general, a pneumatic tire includes a tread portion 10 that is directly in contact with a road surface, a cap ply 20 that is provided within the tread portion 10 and serves as a protective layer of other components, a carcass 30 that forms a frame of the tire, a bead 40 coupled to a rim, an apex 50 that covers the bead 40 to alleviate impact applied to the bead 40, an inner liner 60 that is positioned on an inner side of the carcass 30 and prevents leakage of internal air, a side wall 70 that connects the tread portion 10 and the bead 40 and allows the tire to make a bending and stretching movement, and one or more belts 80 that are installed between the tread portion 10 and the carcass 30. FIGS. 1 and 2 show a cross-sectional structure of general pneumatic tires 1 and 2.

Meanwhile, an aspect ratio of a pneumatic tire is a value obtained by multiplying 100 to a ratio of cross-sectional tire height (H) to a cross-sectional tire width (TSW). In general, a high aspect ratio tire 1 having an aspect ratio equal to or greater than 55 as illustrated in FIG. 1 has excellent ride comfort, noise performance, and the like, and a low aspect ratio tire 2 having an aspect ratio smaller than 55 as illustrated in FIG. 2 has excellent braking, handling, and leaning performance, fuel efficiency, high speed driving safety, and the like, as compared with the high aspect ratio tire 1.

In order to combine the advantages of the two types of the tires described above, conventionally, a tire having an asymmetrical structure in which rim diameters of left and right sides are different with respect to a driving direction has been developed. FIG. 3 shows a cross-section of a conventional tire 3 having an asymmetrical structure.

When the rim diameters of left and right sides are different as described above, ride comfort and handling performance can be enhanced. However, since left and right rigidities of the tire are not symmetrical, a performance of the tire in supporting a vehicle load cannot be optimized

Moreover, handling performance can be slightly enhanced, but various other driving performances of the tire cannot be effectively enhanced.

### PRIOR ART DOCUMENTS

### Patent Documents

Patent Document 1: Korean registered utility model No. 0388349

### SUMMARY OF THE INVENTION

In view of the above, embodiments of the present invention provide a pneumatic tire having an asymmetrical structure, which is capable of effectively securing excellent durability performance and fuel efficiency, as well as enhanced driving performance.

In accordance with an aspect of the present invention, a pneumatic tire including a tread portion, a cap ply, a carcass, an apex, a bead, a side portion, and a belt and having asymmetrical structure with respect to a central line C in a width direction, wherein outer diameters of a left side and a right side are equal, while rim diameters of the left side and the right side are different, and thicknesses of the left side portion and the right side portion are different, can be provided.

Moreover, the pneumatic tire wherein, when the rim diameters of left and right sides are D1 and D2, left and right aspect ratios are S1 and S2, and the thicknesses of the left and right side portions are T1 and T2, the tire satisfies equations: (D1/D2)×(S1/S2)≠1, T1≠T2, can be provided.

Moreover, the pneumatic tire, wherein shapes of left and right patterns of the surface of the tread portion are different, can be provided.

Moreover, the pneumatic tire wherein a pattern for all seasons is formed on any one of the left side and the right side, and a pattern for summer is formed on the other side, can be provided.

Moreover, the pneumatic tire wherein extended lengths of the left carcass and the right carcass are different, so that any one of the left side portion and the right side portion is more reinforced than the other side portion, can be provided.

Moreover, the pneumatic tire, wherein the cap ply is applied to only one of a left end and a right end of the belt, can be provided.

Moreover, the pneumatic tire, wherein cords of the left bead and the right bead are formed in different structure with each other, can be provided.

Moreover, the pneumatic tire, wherein modulus of the left side portion and the right side portion are different, can be provided.

Moreover, the pneumatic tire, wherein a modulus of rubber composition that forms any one of the left side portion and the right side portion is 1.3 times or greater than that of the rubber composition that forms the other side, can be provided.

Moreover, the pneumatic tire, wherein modulus of the left apex and the right apex are different, and a modulus of any one of the left apex and the right apex is 1.2 times or greater than that of the other apex, can be provided.

Moreover, the pneumatic tire, wherein materials of the left apex and the right apex are different, can be provided.

Moreover, the pneumatic tire, wherein an apex that includes a fiber cord on any one of the left side and the right side is used, can be provided.

### BRIEF DESCRIPTION OF THE DRAWINGS

The above and other objects and features of the present invention will become apparent from the following description of embodiments, given in conjunction with the accompanying drawings, in which:

FIG. 1 shows a cross-sectional structure of a conventional high aspect ratio tire;

FIG. 2 shows a cross-sectional structure of a conventional low aspect ratio tire;

FIG. 3 shows a cross-sectional structure of the conventional tire in which the rim diameters of left and right sides are different;

FIG. 4 shows a cross-sectional structure of a pneumatic tire in accordance with an embodiment of the present invention;

FIG. 5 shows a table including data according to comparative simulation results of tire rigidity, rolling resistance, and durability performance of the conventional tires and the pneumatic tire of FIG. 4;

FIG. 6 shows comparative simulation results of strain energy at the end of a belt of the conventional tires and the pneumatic tire of FIG. 4;

FIG. 7 shows comparative simulation results of temperature distributions of the conventional tires and the pneumatic tire of FIG. 4 during driving; and

FIG. 8 shows comparative simulation results of vehicle handling performance of the conventional tires and the pneumatic tire of FIG. 4.

### DETAILED DESCRIPTION OF THE EMBODIMENTS

Hereinafter, specific embodiments to implement a technical concept of the present invention will be described in detail with reference to the accompanying drawings.

Also, in describing the present invention, if it is determined that a detailed description of related known components or functions unnecessarily obscures the gist of the present invention, the detailed description thereof will be omitted.

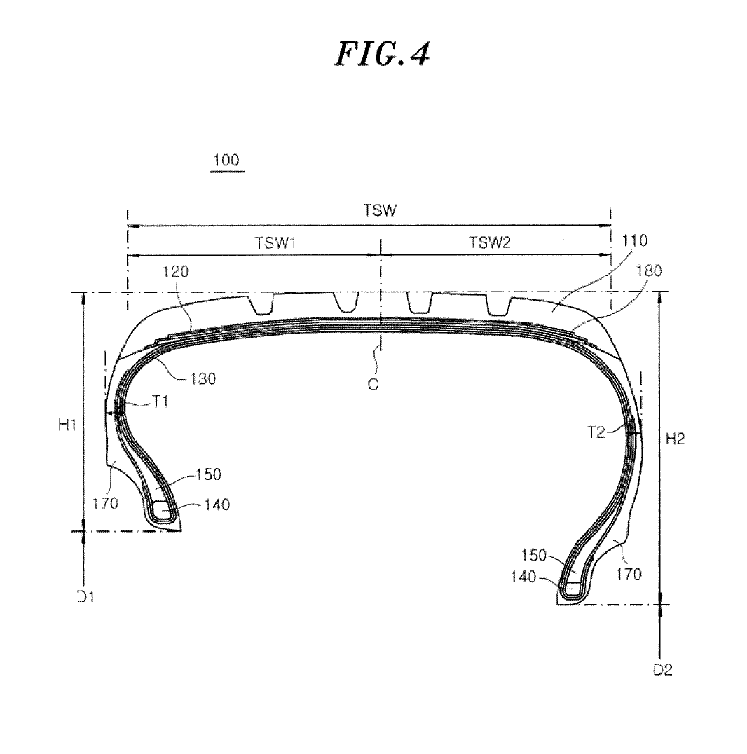

Hereinafter, a pneumatic tire in accordance with an embodiment of the present invention will be described with reference to FIGS. 4 to 8.

FIG. 4 is a view illustrating a cross-sectional structure of a pneumatic tire in accordance with an embodiment of the present invention.

Referring to FIG. 4, a pneumatic tire 100 in accordance with an embodiment of the present invention includes a tread portion 110, a cap ply 120, a carcass 130, a bead 140, an apex 150, a side portion 170, and a belt 180. In the pneumatic tire 100, outer diameters of the right and left portions thereof with respect to a central line C in a width direction may be equal, rim diameters of left and right sides may be different, and thicknesses of the left and right side portions 170 may be different. Here, the width direction refers to a direction in which a rotational axis of the tire 100 extends.

Since the rim diameters of left and right sides of the tire 100 are different, heights of both sides of a cross-section of the tire 100 may be formed to be different. Further, in the pneumatic tire 100 in accordance with an embodiment of the present invention, may have a condition in which the height of the left side and the right side are different, and at the same time, the thickness of the left and right side portions 170 may be different. Here, the side portions 170 are portions that connect the tread portion 110 to the rims in the left and right portions of the tire 100, which may include the carcass 130, an inner liner (not shown), and a side wall as a rubber composition that covers the carcass 130 and the inner liner. Further, the thickness of the side portion 170 refers to the smallest thickness of each of the left and right side portions 170.

Specifically, when it is assumed that the rim diameters of left and right sides the tire 100 are D1 and D2, respectively, the thicknesses of the left and right side portions 170 are T1 and T2, respectively, and the left and right aspect ratios are S1 and S2, respectively, the pneumatic tire 100 in accordance with this embodiment may satisfy Eq. (1) below. Here, the left and right aspect ratios S1 and S2 may be obtained as S1=(H1/TSW)×100 and S2=(H2/TSW)×100, respectively. H1 and H2 are heights of left and right portions of cross-sections of the tire 100, respectively, and TSW(Tread Section Width) is a width of a cross-section of the tire 100.

(D1/D2)×(S1/S2)≠1

T1*T2 Eq. (1)

Further, in the pneumatic tire 100 in accordance with this embodiment, a condition in which the thicknesses of the left side and the right side are different, while a value obtained by multiplying a ratio of the rim diameters of left and right sides and a ratio of the aspect ratios of the left side and the right side is not 1, may be simultaneously satisfied.

Also, in a portion where an aspect ratio is smaller in the left side and the right side, a thickness of the side portion 170 may be greater. That is, when the value S1 is smaller than the value S2, T1 may be greater than T2, and when the value S1 is greater than S2, T1 may be smaller than T2.

Meanwhile, in the pneumatic tire 100 in accordance with another embodiment of the present invention, while the outer diameters of the left side and the right side thereof are equal, the rim diameters of left and right sides may be different, the thicknesses of the left and right side portions 170 may be different, and at the same time, the shapes of left and right patterns of the surface of the tread portion 110 may be different. Here, the shape of the patterns may include a shape of extended patterns, a depth of a recess that forms the patterns, the number of patterns, an interval between the patterns, and the like.

For example, referring to FIG. 4, a pattern shape for all seasons may be applied to the portion TSW2 having a high aspect ratio, and a pattern shape for summer may be applied to the portion TSW1 having a low aspect ratio. Here, the pattern shape for summer may be designed such that the rigidity of a pattern block is greater than the pattern shape for all seasons. However, this is merely an example and the technical concept of the present invention is not limited thereto.

Meanwhile, in the pneumatic tire 100 in accordance with another embodiment of the present invention, extended lengths of the left and right carcasses 130 may be different. For example, an extended length of any one of the left and right carcasses 130 may be greater than that of the other. In this case, the rigidity of the tire 100 of the greater extended length of the carcass 130 may increase, forming an asymmetrical structure.

Meanwhile, in the pneumatic tire 100 in accordance with another embodiment of the present invention, the cap ply 120 may be applied to only any one of ends of left and right belts 180, and the cap ply 120 may not be applied to the other of the ends of the left and right belts 180. In this case, the rigidity of the tire 100 in the side where the cap ply 120 is applied may increase, forming an asymmetrical structure.

Meanwhile, in the pneumatic tire 100 in accordance with another embodiment of the present invention, cord structures of the left and right beads 140 may be configured to be different. The cord structures of the beads 140 may include a material of the beads 140, a shape of the beads 140, rigidity of the beads 140, and the like. In this case, the rigidities of both sides of the tire 100 may be different, forming an asymmetrical structure.

Meanwhile, in the pneumatic tire 100 in accordance with another embodiment of the present invention, modulus of the left and right side portions 170 may be different. For example, modulus of rubber compositions that form the side portions 170 may be different. Specifically, a modulus of rubber composition that forms any one of the left and right side portions 170 may be 1.3 times or greater than that of the rubber composition that forms the other side. In another example, modulus of the left and right apexes 150 that are provided within the side portions 170 may be different. In this case, a modulus of one apex 150 may be 1.2 times or greater than that of the other apex 150.

Meanwhile, in the pneumatic tire 100 in accordance with another embodiment of the present invention, materials of the left and right apexes 150 may be different. For example, one apex 150 that includes a fiber cord may be provided on any one of the left and right sides, and an apex 150 that does not include a fiber code may be provided on the other side.

The various embodiments described above may be applied to one pneumatic tire 100, or two or more embodiments may be combined to be applied to one pneumatic tire 100. When two or more embodiments are combined, the embodiments may be combined such that left and right sides are asymmetrical with respect to a central line of the tire 100 in a circumferential direction.

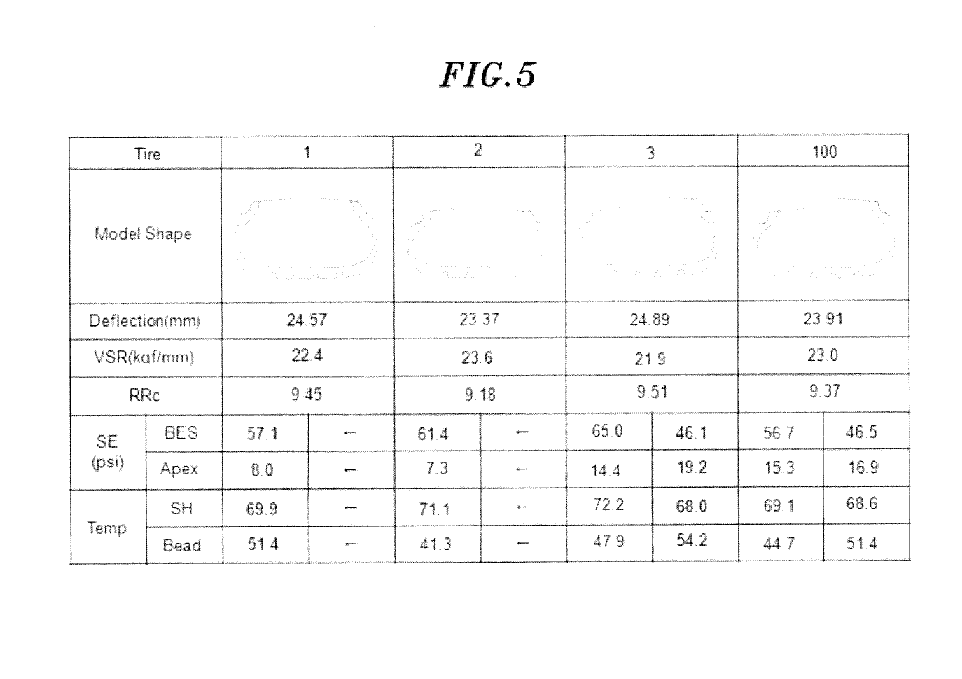

FIG. 5 is a table illustrating data according to comparative simulation results of tire rigidity, rolling resistance, and durability performance of the conventional tires 1 to 3 and the present tire of FIG. 4.

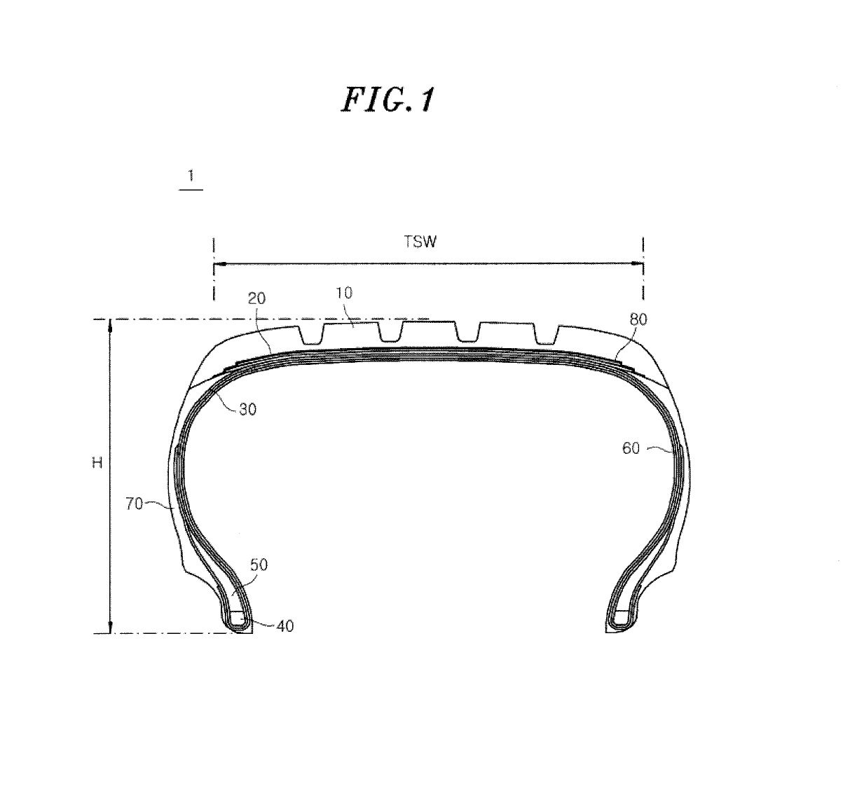

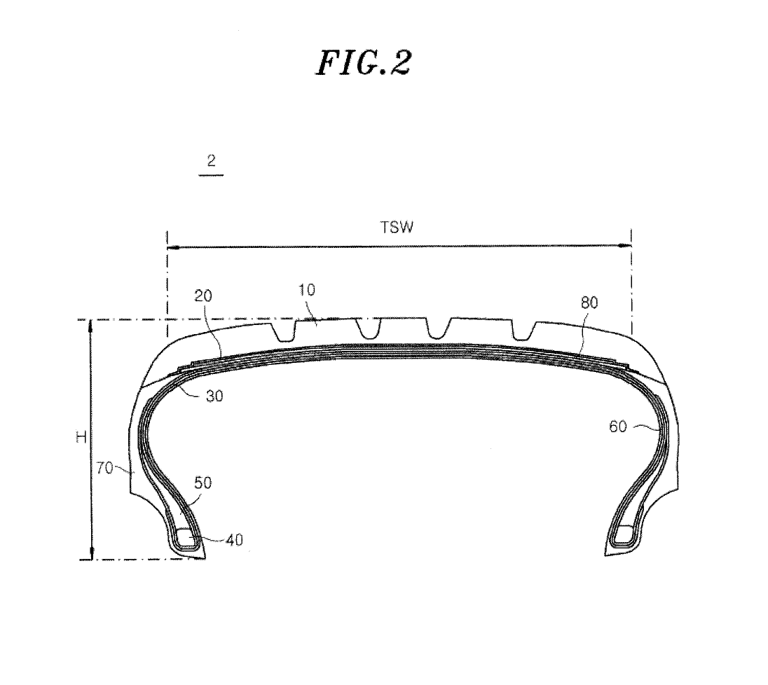

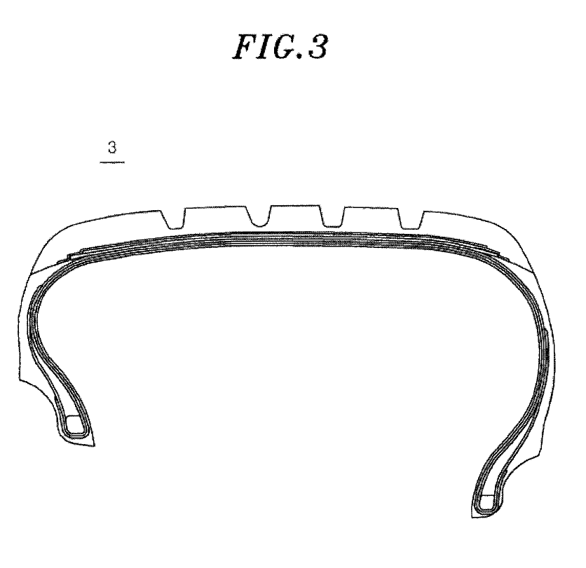

In the table of FIG. 5, simulation results of the conventional tire 1 (FIG. 1) having a high aspect ratio, the conventional tire 2 (FIG. 2) having a low aspect ratio, and the present tire 3 (FIG. 3),in which the rim diameters of left and right sides were different, and the pneumatic tire 100 of the present embodiment are illustrated from the left columns. In the pneumatic tire 100 of the present embodiment, the rim diameters of left and right sides and the aspect ratios satisfied (D1/D2)×(S1/S2)=1.027, and a thickness of the side portion in the side where the diameter of the rim was greater is 1.1 times that of the other side portion. Further, a turn-up height of the carcass in the side where the diameter of the rim was greater was higher and Flipper with a fiber cord was applied to the apex.

FIG. 5 shows the finite element analysis (FEA) results of a vertical spring rate (VSR), a rolling resistance coefficient (RRc), and durability performance of the tires by applying an air pressure of 30 psi and a load of 500 kgf. Referring to FIG. 5, when the asymmetrical tire 100 of the present embodiment was applied, the vertical spring rate (VSR) of the tire 100 was enhanced compared with the present tire 3 in which only the rim diameters of left and right sides are different or the conventional tire 2 having a low aspect ratio. Further, the asymmetrical tire 100 of the present embodiment has the rolling resistance coefficient (RRc) smaller than those of the conventional tire 3 in which only the rim diameters of left and right sides are different or the conventional tire 1 having a high aspect ratio. Fuel efficiency may be enhanced as RRc is reduced.

When the asymmetrical tire 100 of the present embodiment is applied, the rigidity of the tire greater than that of the conventional tire 2 having a low aspect ratio can be secured and fuel efficiency can be enhanced compared with the case of using the tire 1 having a high aspect ratio. Further, an effect greater than the case of applying the conventional tire 3 in which only the rim diameters of left and right sides are different can be obtained.

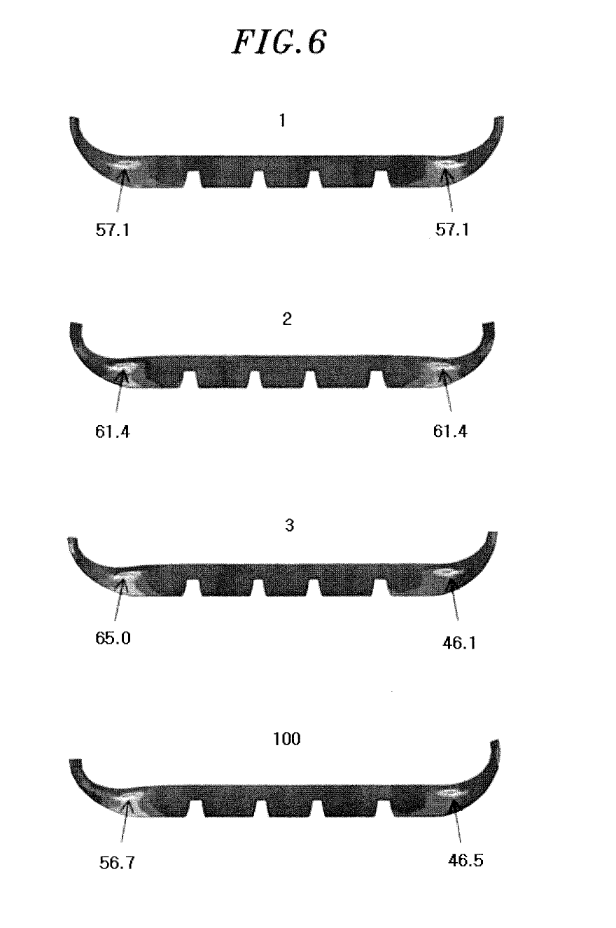

FIG. 6 is a view illustrating comparative simulation results of strain energy in the ends of belts of the conventional tires (FIGS. 1 to 3) and the present tire of FIG. 4.

In FIG. 6, simulation results of the conventional tire 1 having a high aspect ratio, the conventional tire 2 having a low aspect ratio, and the conventional tire 3 in which the rim diameters of left and right sides were different, and the pneumatic tire 100 of the present embodiment are illustrated from above.

In FIG. 6, strain energy in the ends of the belts when the same load was applied in the standard air pressure was interpreted to be indicated as colors and numerical values. In general, when a load is applied, the ends of the belts formed of steel are most vulnerable, and as a strain energy value increases, durability performance is reduced. Referring to FIG. 6, the asymmetrical tire 100 of the present embodiment has a strain energy value substantially lower than those of the conventional tire 1 having a high aspect ratio, the conventional tire 2 having a low aspect ratio, and the conventional tire 3 in which rim diameters of left and right sides are different.

Thus, it can be seen that the asymmetrical tire 100 of the present embodiment exhibits enhanced durability performance, compared with the conventional tires 1, 2 and 3.

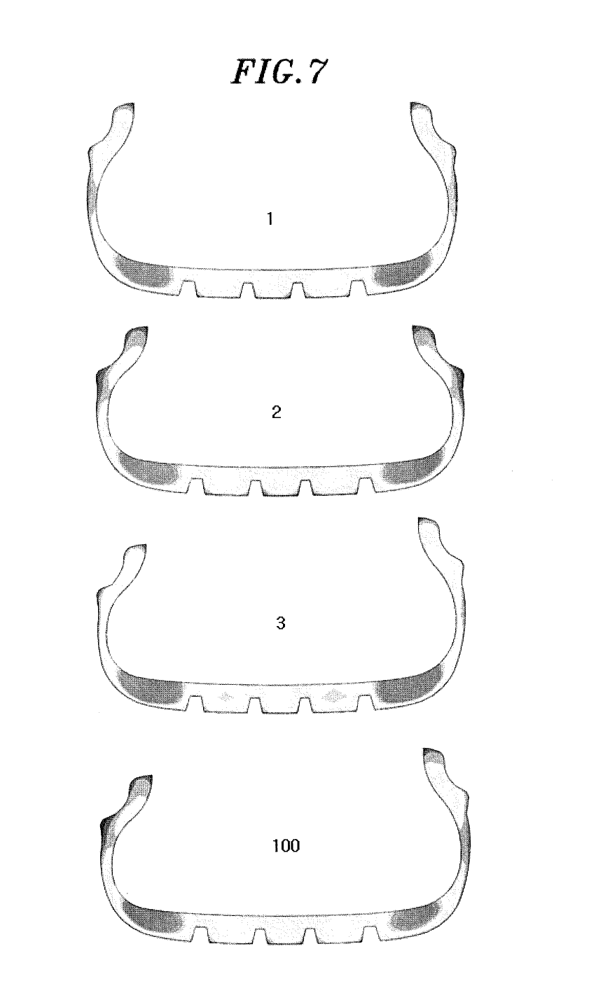

FIG. 7 is a view illustrating comparative simulation results of temperature distributions of the conventional tires (FIGS. 1 to 3) and the pneumatic tire of FIG. 4 during driving.

In FIG. 7, simulation results of the conventional tire 1 having a high aspect ratio, the conventional tire 2 having a low aspect ratio, and the conventional tire 3 in which the rim diameters of left and right sides were different, and the pneumatic tire 100 of the present embodiment are illustrated from above. The pneumatic tire 100 of the present embodiment has the same asymmetrical structure as that of the simulation of FIG. 5 described above.

In FIG. 7, temperature distributions generated within the tires when the same load was applied in the standard air pressure and the tires rotated at a speed of 80 km/h were interpreted to be shown. As for temperature, the ends of the belts were most vulnerable, and referring to FIG. 7, the asymmetrical tire 100 of the present embodiment has a lower temperature distribution, compared with the conventional tire 1 having a high aspect ratio, the conventional tire 2 having a low aspect ratio, and the present tire 3 in which the rim diameters of left and right sides were different.

That is, it can be seen that the asymmetrical tire 100 of the present embodiment also has an effect of enhanced heating performance during driving, compared with the conventional tires 1, 2, and the present tire 3.

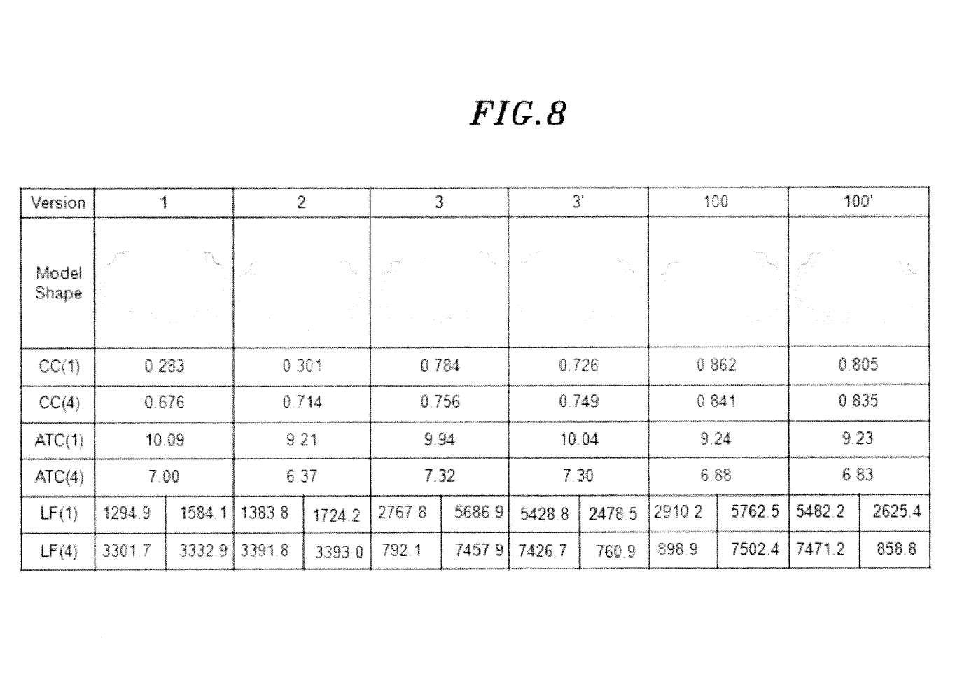

FIG. 8 is a view illustrating comparative simulation results of vehicle handling performance of the conventional tires (FIGS. 1 to 3) and the pneumatic tire of FIG. 4.

In the table of FIG. 8, simulation results of the conventional tire 1 having a high aspect ratio, the conventional tire 2 having a low aspect ratio, and the present tires 3 and 3′ in which the rim diameters of left and right sides were different and the left and right were interchanged, the pneumatic tire 100 of the present embodiment, and tires 100 and 100′ in which the left and right were changed are illustrated from the left columns. In the pneumatic tire 100 of the present embodiment, the rim diameters of left and right sides and the aspect ratios satisfied (D1/D2)×(S1/S2)=0.974 and the other conditions are the same as those of the asymmetrical structure applied in the simulation of FIG. 5 described above.

In FIG. 8, the results of analysis of force & moment by applying the same load in the standard air pressure are illustrated. Here, cornering coefficient (CC) and aligning torque coefficient (ATC) denote handling performance and handling stability. The handling stability may be tested by releasing the tire at a predetermined angle (slip angle) with respect to a driving direction, and the numbers within the parentheses denote slip angles. Further, lateral force (LF) may be generated when a tire is moved out of a driving direction, denoting a force by which the tire may endure without being collapsed when moving out of the driving direction. In general, it is meant that handling stability is excellent as the CC value is greater, as the ATC value is smaller, and as the LF value is greater.

Referring to FIG. 8, when the asymmetrical tires 100 and 100′ of the present embodiment are applied, the CC value and the LF values thereof were greater than those of the conventional tire 1 having a high aspect ratio and the conventional tire 2 having a low aspect ratio. Thus, it can be seen that handling performance or handling stability of the asymmetrical tires 100 and 100′ were enhanced higher than those of the conventional symmetrical tires, regardless of size of the aspect ratios.

Further, the CC value and the LF value of the asymmetrical tires 100 and 100° of the present embodiment were greater than those of the tires 3 and 3′ in which only the rim diameters of left and right sides were different. In consideration of the simulation results of FIGS. 5 to 7, the asymmetrical tires 100 of the present embodiment has higher handling stability and superior durability performance, fuel efficiency, and heating performance, than or to those the present asymmetrical tires 3 and 3′ in which only the rim diameters of left and right sides are different.

In accordance with the embodiments of the present invention, it is possible to improve durability performance, fuel efficiency and heating performance, as well as driving performance of a vehicle.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A pneumatic tire including a tread portion, a cap ply, a carcass, an apex, a bead, a side portion, and a belt and having asymmetrical structure with respect to a central line C in a width direction,
wherein outer diameters of a left side and a right side are equal, while rim diameters of the left side and the right side are different, and thicknesses of the left side portion and the right side portion are different.

2. The pneumatic tire of claim 1, wherein, when the rim diameters of left and right sides are D1 and D2, left and right aspect ratios are S1 and S2, and the thicknesses of the left and right side portions are T1 and T2, the tire satisfies equations:
(D1/D2)×(S1/S2)≠1
T1*T2 Eq. (1)

3. The pneumatic tire of claim 1, wherein shapes of left and right patterns of the surface of the tread portion are different.

4. The pneumatic tire of claim 3, wherein a pattern for all seasons is formed on any one of the left side and the right side, and a pattern for summer is formed on the other side.

5. The pneumatic tire of claim 1, wherein extended lengths of the left carcass and the right carcass are different, so that any one of the left side portion and the right side portion is more reinforced than the other side portion.

6. The pneumatic tire of claim 1, wherein the cap ply is applied to only one of a left end and a right end of the belt.

7. The pneumatic tire of claim 1, wherein cords of the left bead and the right bead are formed in different structure with each other.

8. The pneumatic tire of claim 1, wherein modulus of the left side portion and the right side portion are different.

9. The pneumatic tire of claim 8, wherein a modulus of rubber composition that forms any one of the left side portion and the right side portion is 1.3 times or greater than that of the rubber composition that forms the other side.

10. The pneumatic tire of claim 8, wherein modulus of the left apex and the right apex are different, and a modulus of any one of the left apex and the right apex is 1.2 times or greater than that of the other apex.

11. The pneumatic tire of claim 1, wherein materials of the left apex and the right apex are different.

12. The pneumatic tire of claim 11, wherein an apex that includes a fiber cord on any one of the left side and the right side is used.
